(19) United States
(12) Patent Application Publication
(10) Pub. No.: US 2019/0294975 A1
(43) Pub. Date: Sep. 26, 2019

(54) PREDICTING USING DIGITAL TWINS

(71) Applicant: Swim.IT Inc, San Jose, CA (US)

(72) Inventor: Christopher David SACHS, Sunnyvale, CA (US)

(21) Appl. No.: 15/928,053

(22) Filed: Mar. 21, 2018

(51) Int. Cl. G06N 5/02; G06N 3/08

(52) U.S. Cl. CPC G06N 5/022; G06N 3/08

(57) ABSTRACT

In various examples there is a computer-implemented method performed by a digital twin at a computing device in a communications network. The method comprises: receiving at least one stream of event data observed from the environment. Computing at least one schema from the stream of event data, the schema being a concise representation of the stream of event data. Participating in a distributed inference process by sending information about the schema or the received event stream to at least one other digital twin in the communications network and receiving information about schemas or received event streams from the other digital twin. Computing comparisons of the sent and received information. Aggregating the digital twin and the other digital twin, or defining a relationship between the digital twin and the other digital twin on the basis of the comparison.

### BACKGROUND

The present technology is concerned with digital twins which are digital representations of physical objects or processes. Digital twins are used in many application domains including product and process engineering, internet of things, logistics, asset management, and others. The digital twin provides a model of the behavior of the physical object and once such digital representations are available it is possible for automated computing systems to use the digital twins to facilitate management and control of the physical objects.

Digital twins are often manually created by an operator or expert who is familiar with the physical objects to be represented and understands how the physical objects behave and/or interact with one another. However, it is time consuming and burdensome to form digital twins in this way and difficult to scale the process up for situations where there are huge numbers of digital twins to be formed.

The embodiments described below are not limited to implementations which solve any or all of the disadvantages of known apparatus and methods for digital twins.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a computer-implemented method performed by a digital twin at a computing device in a communications network. The method comprises: receiving at least one stream of event data observed from the environment. Computing at least one schema from the stream of event data, the schema being a concise representation of the stream of event data. Participating in a distributed inference process by sending information about the schema or the received event stream to at least one other digital twin in the communications network and receiving information about schemas or received event streams from the other digital twin. Computing comparisons of the sent and received information. Aggregating the digital twin and the other digital twin, or defining a relationship between the digital twin and the other digital twin on the basis of the comparison.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of digital twins and corresponding physical entities;

FIG. 2 is a schematic diagram of a digital twin;

FIG. 3 is a flow diagram of a method of operation at a digital twin which includes computing predictions at test time and also includes online training;

FIG. 4 is a flow diagram of a method of replacing a first machine learning component by a second machine learning component;

FIG. 5A is a schematic diagram of a neural network architecture at a digital twin;

FIG. 5B is a schematic diagram of the neural network architecture of FIG. 5A and showing an appending operation;

FIG. 6 is a flow diagram of a method of achieving efficiencies during a learning process at a machine learning component such as that of FIG. 2;

FIG. 7 is a flow diagram of a method of retraining a machine learning component on selected saved training data in particular circumstances;

FIG. 8 is a schematic diagram of a parent digital twin and child digital twins;

FIG. 9 is a schematic diagram of physical entities in the real world and showing a high level process for inferring digital twins of the physical entities from event data streams related to behavior of the physical entities;

FIG. 10 is a schematic diagram of a structural type system hierarchy;

FIG. 11 is a flow diagram of a method of structural type inference;

FIG. 12 is a schematic diagram of a process of computing a dynamic schema;

FIG. 13 is a flow diagram of a method of distributed inference;

FIG. 14 illustrates an exemplary computing-based device in which embodiments of a digital twin is implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

As mentioned above a digital twin is a digital representation of a physical object or process (referred to herein as a physical entity). A digital twin of a physical object or real world process comprises software which simulates or describes event data about the behavior of the physical object or real world process. The event data is obtained by monitoring the physical objects or processes, for example, using capture apparatus in the environment of the physical object or process. Additionally or alternatively sensors instrumenting the physical objects or processes are used to obtain the event data.

It is not straightforward to automatically compute a digital twin and enable it to predict future events or state of the digital twin in a manner which takes into account state information from other digital twins in the environment. This is not only because of the large amounts of data involved but because the event data is heterogeneous structured data. Finding a way to deal with this type of data in an efficient practical manner is difficult.

It is an additional challenge to achieve automatic computation of digital twins which are able to learn in an online manner so as to be able to take into account changes in the incoming event data. To achieve such digital twin functionality without using cloud computing resources such as a data center is especially difficult since the amounts and rates of data involved are extremely large and since the complexity of the task is one which lends itself to availability of plentiful computing resources.

Another problem is that conventional machine learning technology typically expects input data in a known format and size and breaks down or computes erroneous predictions if the input data is not suitable. In the case of a digital twin receiving heterogeneous structured input data from a variety of sources it is not easy to find a way to use conventional machine learning technology. Typically a data scientist has to spend considerable time and effort to select, format, normalize, and clean data, sometimes padding it with zeros to bring it to the correct size, before it is suitable to input to a machine learning system. However, availability of a human data scientist is not an option for applications where fully automated creation and online training of digital twins is desired.

The data which the digital twin is to describe and predict is “dark” data in that no semantic information is available regarding the meaning of the data. This makes it especially difficult to design an automated system to create digital twins, train them and use them to make predictions suitable for controlling or managing or maintaining physical entities in the real world.

Most conventional machine learning systems use offline training whereby the machine learning system is taken offline and is unavailable for computing test time predictions, during a training phase. However, digital twins need to be able to operate continually and it is not acceptable to take them offline to carry out training. This is because there would be consequential problems for management, maintenance or control of physical entities which the digital twins represent. Therefore an online training solution is needed. However, training algorithms for machine learning systems are computationally resource intensive and time consuming. Therefore it is a challenge to create a way to achieve high quality training which is computed online, at the same time as the digital twins are being used to compute predictions for controlling, configuring or maintaining the physical entities.

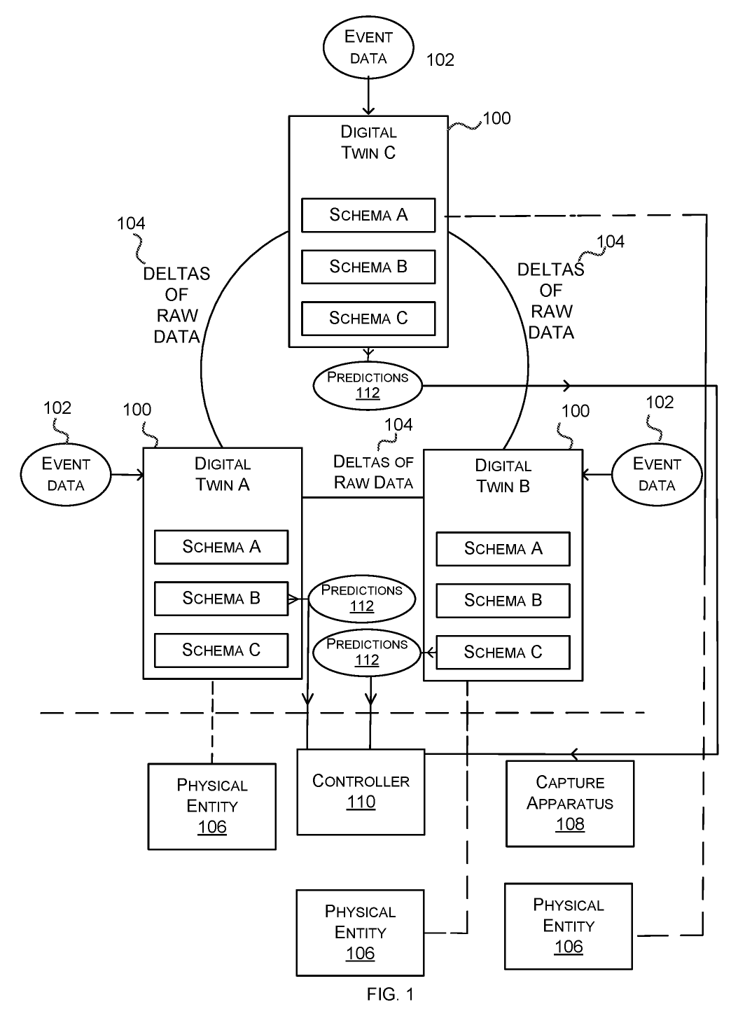

FIG. 1 is a schematic diagram of a plurality of digital twins 100 and one or more event data 102 streams which are observed from the behavior of physical entities 106 in the real world. Each digital twin is a node of a communications network (not illustrated in FIG. 1 for clarity) so that the digital twins are able to communicate with one another. Each digital twin has its own event data 102 stream as direct input and also receives data from one or more of the other digital twins as described below. Each digital twin represents a physical entity 106 in the real world where the real world is indicated below the dotted line in FIG. 1. Thus in FIG. 1 digital twin A is linked by a dotted line to a physical entity 106 which is the physical entity that it represents. Digital twin B is linked by a dotted line to a physical entity 106 which is the physical entity that it represents and so on for digital twin C. A controller 110 in the real world is one or more physical apparatus which receives predictions 112 from the digital twins and facilitates control of the physical entities 106. In some cases the controller 110 sends instructions to the physical entities 106 which are automatically executed by the physical entities 106.

The event data 102 is captured by capture apparatus 108 which is any type of sensor or other apparatus for capturing data about the behavior of the physical entities 106. In FIG. 1 only one capture apparatus 102 is shown for clarity, although in practice there are many capture apparatuses. The physical entities 106 are any physical objects or processes where it is required to capture and analyze data about the behavior of the physical entities 106. In the case that a physical entity 106 comprises a process the physical entity 106 is something which is able to carry out a process, such as a manufacturing apparatus, a router in a telecommunications network, a traffic light. A non-exhaustive list of examples of physical entities 106 is: street light, traffic signal installation, domestic appliance, automotive vehicle, logistics asset, power distribution network equipment.

The event data 102 stream is a real time stream of event data. A non-exhaustive list of examples of event data is: temperature measurements, ambient light levels, latitude and longitude data, power level, error rate and many other data values associated with events in the behavior of the physical entities 106. Each event data 102 item is associated with a time of occurrence of the event and these times are referred to as time stamps.

The event data 102 is input to a digital twin 100 which, in some examples, is an edge device at the edge of the internet or other communications network. A digital twin 100 does not have to be at an edge device and in some cases is located at the core of a communications network. Note that FIG. 1 shows three digital twins 100 although in practice there are many of these. Each digital twin has a schema which is a concise representation of the event data 102 stream associated with the digital twin (that is the event data stream directly received at the digital twin). The schema comprises one or more structural types from a hierarchy of structural types. The schema is configured manually by a human operator in some examples. In other examples the schema is automatically computed by the digital twin itself by compressing the event data 102 as described in more detail later in this document. Thus in FIG. 1 digital twin has schema A which is the schema representing the event data directly input to digital twin A.

Each digital twin knows about other digital twins in its environment since this data is available to it from another computing system (not illustrated in FIG. 1) or by manual configuration. Each digital twin has the schema of each other digital twin since the digital twins send their schemas to one another over the communications network. Thus digital twin A has schema B which is the schema of digital twin B and it also has schema C which is the schema of digital twin C. If the event data stream of a digital twin changes significantly the schema of the digital twin will also change since it is a concise representation of the event data stream. The new schema is communicated to the other digital twins in that situation.

The task of a digital twin is to represent the physical entity associated with the digital twin, learn from the event data 102 and state data received from other digital twins, and predict the behavior of the physical entity in the context of its environment of other digital twins, to enable control and/or configuration and/or maintenance of the physical entity. The task of the digital twin is to be achieved with no or minimal human input and without semantic information about the physical entities.

The digital twins exchange (also referred to as gossip) their event data. Since the event data is at a high rate and is large, differences or deltas of the event data 104 are exchanged between the digital twins as indicated in FIG. 1. The deltas are computed as differences between time intervals of the event data. For example, the event data during a first time interval is compared with the event data during a second time interval to compute a delta which is communicated to others of the digital twins. Thus when a digital twin receives event data from another digital twin, it receives the event data in a de-duplicated form by receiving, for individual ones of the streams, deltas which are differences between already received event data of the stream and more recent event data of the stream.

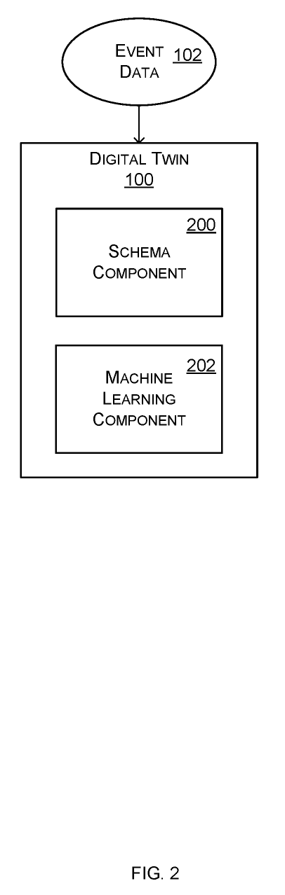

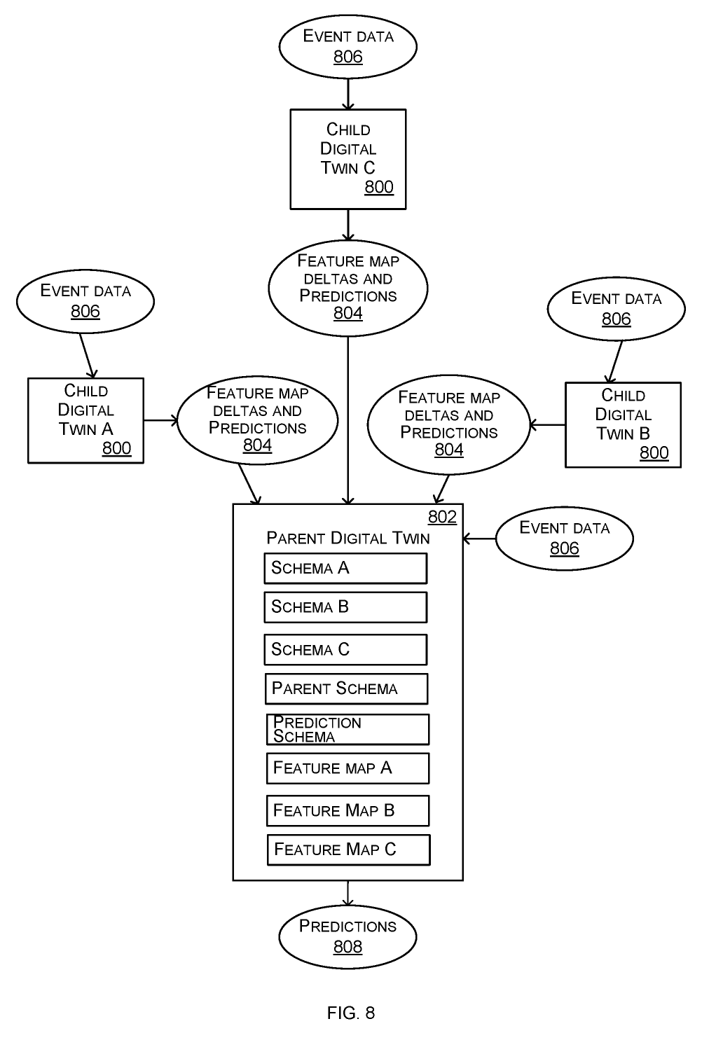

FIG. 2 is a schematic diagram of a digital twin 100 which is at a computing device. Some but not all of the components of the digital twin are illustrated in FIG. 2 and FIG. 8 describes the components of a digital twin in more detail. The digital twin has a schema component 200 which in some cases receives a manually configured schema for the digital twin, and in some cases automatically infers the schema describing the event data 102 input to the digital twin. The schema component also sends and receives schemas with other digital twins and stores the schemas it knows about. Detail about how a digital twin automatically infers the schema describing the event data is given in US patent application “Inferring digital twins” filed on the same day as the present application and with the same inventors as the present application.

The digital twin has a machine learning component 202 which comprises any machine learning technology including but not limited to: a neural network, a random decision forest, a support vector machine, a probabilistic program or other machine learning technology.

The machine learning component is configured to receive input in a specified form referred to herein as an input structure. The input structure has a defined format comprising a tensor of columns and rows, with each column storing state data at a given time step and where the columns of state data are in chronological order in the input structure. A time step is a time interval such as a second, a minute, an hour, a day or other length of time. Each row of the tensor comprises state data over time steps for a specified field of a schema. It is recognized herein that it is also possible to have the rows of the tensor holding state data at individual time steps and the columns to hold state data over time steps for a specified field of the schema.

The machine learning component is configured to learn by predicting event data, observing the corresponding empirical event data, computing an error between the predicted and observed event data and using an update process to update itself. Any suitable update process is used depending on the type of machine learning technology in the machine learning component.

The machine learning component is also configured to predict event data for use in controlling, managing or maintaining the physical entities. These predictions are made as an integral part of the learning process so that online learning takes place together with test time prediction. In some examples, the machine learning component is used to predict behavior of the physical entity in a hypothetical situation as described in more detail later in this document.

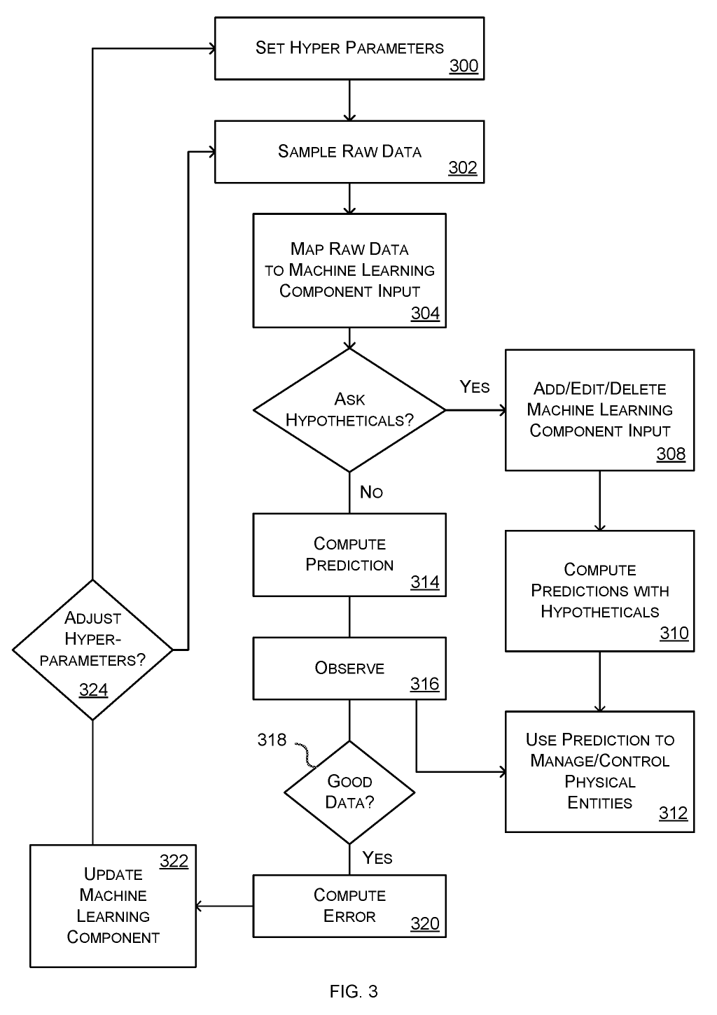

FIG. 3 is a flow diagram of a method of operation of at a digital twin. Hyperparameters are set 300 in order to control how the online learning and other behavior of the digital twin proceeds. The hyperparameters are described in more detail later.

The digital twin takes 302 samples of raw event data that it receives, or of deltas 104 of the raw event data, during a time window. The duration of the time window is one of the hyperparameters set at operation 300. The samples are from data of other digital twins and also of event data received directly at the digital twin itself.

The digital twin maps the samples of raw event data, or of deltas of raw event data, into the input structure of the machine learning component 304. The mapping is computed on the basis of the schemas of the digital twins. Samples from digital twin B are mapped to the input structure using schema B. Samples from digital twin C are mapped to the input structure using schema C and so on. Thus the samples from a particular digital twin are mapped to the input structure using the schema of the particular digital twin.

As mentioned above a schema is a concise representation of the event data received at a digital twin and it comprises one or more structural types and optional metadata. A structural type has information about the structure of the event data and about the content of the event data. The structural type is one of a plurality of specified structural types from a hierarchy of structural types. The hierarchy of structural types is described below.

In an example, the structural type is a range and the schema comprises numerical values defining the range. This describes event data where the event data comprises numerical values within the range. The digital twin receives samples of the range type and maps them to the input structure by putting the sampled values into a row of the input structure. In some cases the digital twin normalizes the sampled values according to the range before entering the normalized values into the input structure. Thus each row of the input structure has an associated structural type and comprises numerical values computed from the samples of that structural type.

In an example, the mapping of the event data into the input structure comprises using a reduction function. The reduction function acts to aggregate or compress event data items received in a single time step. In an example, where a time step is one day, and the aggregation comprises a weighted average, the reduction function computes a weighted average of the event data items received during the day. The weights are related to the frequency of occurrence of the particular data items. Note that it is not essential to use a weighted average as other types of aggregation are used in some examples. The reduction function is specified in the schema. By using a reduction function in this way, data compression is achieved which helps with making the digital twin work even for huge amounts of incoming data. The reduction function also helps to reduce the effects of noise in the incoming event data.

In an example, the input structure is a specified size and the number of rows and the number of columns of the input structure are hyperparameters which are set at operation 300.

If the apparatus controlling, managing or maintaining the physical entities wants to ask the digital twin what the physical entity will do in a hypothetical situation the check at operation 306 is answered in the affirmative. In an example, an apparatus controlling, managing or maintaining the physical entity or physical entities sends a request to the digital twin comprising the hypothetical situation details. In response the digital twin adds or edits or deletes data in the input structure. The modified input structure is then used to compute 310 a prediction and the prediction is used 312 to control, manage or maintain the physical entity. In an example, the physical entities are traffic lights. The hypothetical situation is a new behavior of a particular traffic light and the prediction is a predicted traffic behavior.

If no hypotheticals are asked at check 306 the machine learning component computes 314 a prediction using the filled input structure. The digital twin observes 316 the corresponding empirical event data and checks 318 if the observations are good data or not. If noise has introduced outliers in the empirical event data it is not good data in which case the process returns to operation 314 to compute further predictions and make further observations.

If the empirical data meets criteria which indicate that it is suitable for use in a training process, an error is computed 320 between the empirical data and the prediction 314. The error is used to update 322 the machine learning component using a suitable update procedure according to the type of machine learning technology.

A check is made at operation 324 as to whether to update the hyperparameters or not. The check involves using thresholds, rules or other criteria to decide whether to change the size of the sampling window and/or change the size of the input structure.

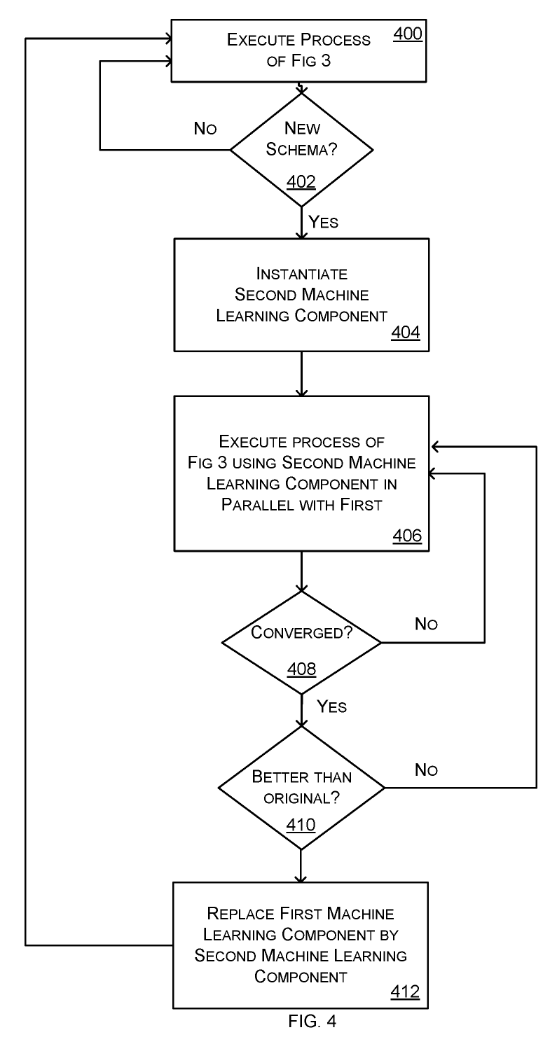

As mentioned above the schema of a digital twin sometimes changes with time. If the schema does change, or the schema of one of the other digital twins changes, the process of FIG. 4 is used. This is because the machine learning component needs to be retrained to work with the new schema and this cannot be done using online learning. Therefore the process of FIG. 4 is used.

Suppose the process of FIG. 3 is executing 400 at a digital twin. The digital twin checks 402 whether it receives a new schema or has computed its own new schema. If so it instantiates 404 a second machine learning component at the digital twin. The second machine learning component 404 has not yet been trained and comprises default or random parameter values. The digital twin executes 406 the process of FIG. 3 using the second machine learning component and the new schema in parallel with execution of the first machine learning component and the old schema.

Once the second machine learning component has been trained so that convergence is reached at check point 408, the error rate of the second machine learning component is stable. A second check is then made at check 410 to see if the performance of the second machine learning component is better than the first machine learning component. If so, the first machine learning component is replaced 412 by the second machine learning component. If not, the second machine learning component is discarded.

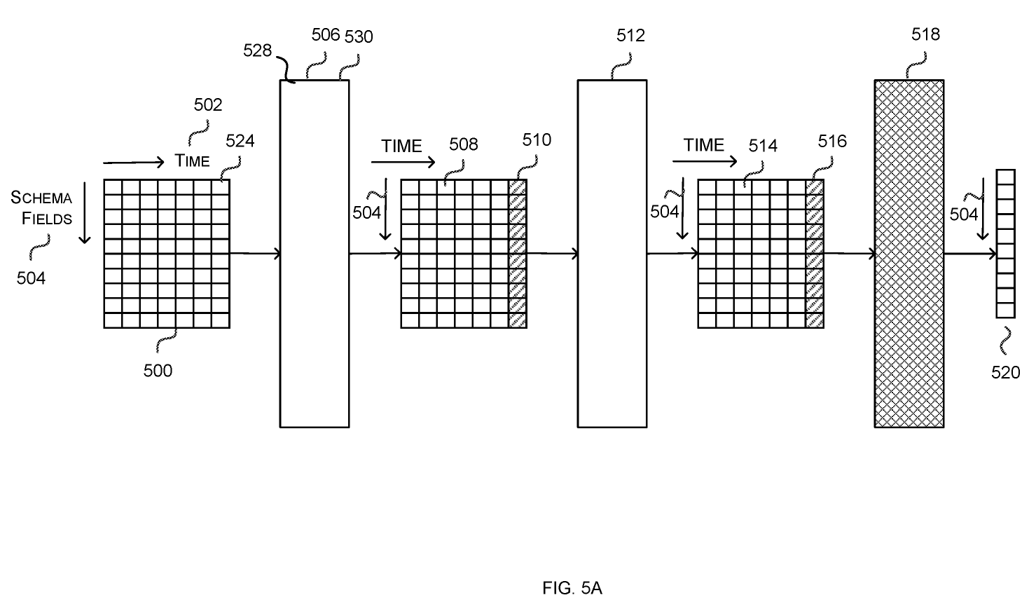

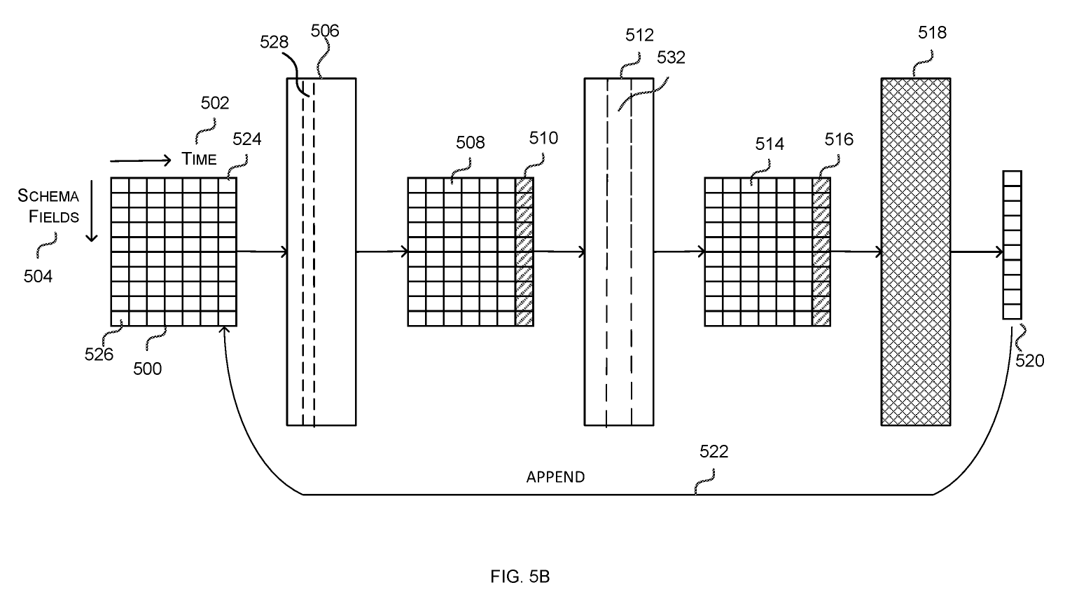

FIG. 5A is a schematic diagram of an example machine learning component for use in a digital twin. This is an example only and is not intended to limit the scope of the technology since other types of machine learning are used in some examples.

FIG. 5A shows an input structure comprising a tensor 500 of columns and rows. The tensor is equivalent to an image in many respects and so is operable with machine learning technology typically used for image processing. The columns 502 each contain state data in a different time step and the rows 504 contain schema fields. The input structure is input to a convolutional neural network layer 506 which computes a feature map 508 as output. The feature map is input to a second convolutional neural network layer 512 which computes a second feature map 514 as output.

Using a convolutional neural network in the context of the present technology gives unexpected benefits. Typically convolutional neural networks are used for image processing where spatial information is contained in the image so that there are relationships expected between rows and columns of the image. In contrast, the present technology does not use images as inputs but rather has matrices formed from time steps of data from schema fields of event streams. Relationships are not expected between the schema field data. However, it is unexpectedly found that using convolution where the convolutional filters span both one or more time steps and one or more schema fields gives good quality prediction results.

Each feature map has columns, one column per time step. Each row of a feature map has results from a different convolutional filter of a convolutional neural network layer 506, 512. In a preferred embodiment, each convolutional neural network layer 506 has a plurality of different convolutional filters which are the same height as a column of the input tensor but which have different widths, where the widths correspond to numbers of time steps. By using convolutional filters which are the same height as one another efficiencies are gained without significantly sacrificing accuracy. In other example, both the width and height of the convolutional filters varies.

The effect of a convolutional neural network layer can be thought of as sliding each convolutional filter over the input tensor, from column to column, and computing a convolution, which is an aggregation of the neural network node signals falling within the footprint of the filter, at each position of the filter as it is slid from column to column. This gives a convolution result, which aggregates each schema field over the time steps that fall within the footprint of the filter. For a given column, there is a convolution result from each convolutional filter. One of the convolution results is selected and stored in the corresponding feature map column. In an example, the selection is done by selecting the maximum convolution result.

The second feature map 514 is input to a fully connected neural network layer 518 which is an output layer in this architecture. The fully connected layer 518 computes an output vector 520 of the same length as a column of the input tensor. The output vector 520 is a column of predicted schema field values for the predicted time step; it is a regression result and not a classification result as the neural network is not performing classification.

In the example of FIG. 5A a single fully connected layer 518 is illustrated. However, in some examples, a plurality of fully connected layers 518 are connected in series. This enables more neurons to be added to the neural network without an explosion of interconnections resulting.

The mapping that was done from the event data to the input structure using the schemas is applied in reverse to the output vector 520. Thus any normalization that was applied to the sampled data as it was mapped to the input structure is applied in reverse to the output vector 520 to obtain predictions of the state of the digital twins at a future time step which is the next time step in the chronological sequence of the columns of the input structure. The reverse mapping gives the benefit that the output vector 520 is quickly, simply and efficiently converted into a format suitable for use by legacy computing systems. The legacy computing systems are ones which were originally designed to work with the raw event data. In an example, the event data is produced by the capture apparatus in extensible mark-up language formal (XML format), or in Java (trade mark) script object notation (JSON) format. The machine learning component maps the XML formatted event data into a tensor for input to the machine learning component. The output vector of the neural network is then reverse mapped into the original XML or JSON format. In this way the prediction of the neural network is available in XML format or JSON format and is available for use by computing systems which expect XML or JSON format input.

FIG. 5B is a copy of FIG. 5A and showing detail about how the prediction process is repeated in order to predict forward for a plurality of forecast time steps. FIG. 5B illustrates schematically a convolutional filter 528 the functionality of which is provided by the convolutional neural network layer 506. The effect of the convolutional neural network layer can be thought of as sliding convolutional filters 528 over input tensor 502 during a convolution process.

FIG. 5B illustrates schematically how the machine learning component is used to predict forward several time steps into the future. Once the output vector 520 is available this is added as a pre-fix onto the input tensor 502 as indicated by dotted column 524 in FIG. 5B and arrow 522. In order to keep the size of the input tensor 502 constant the column 526 holding the oldest data is deleted. The input tensor 502 is then used to compute a new output vector 520 which is added as a pre-fix onto the input tensor 502 and so on, in order to predict a time sequence of output vectors 520 into the future.

In some examples, pooling is used in conjunction with the neural network architecture of FIGS. 5A and 5B. In the case of pooling the feature map 508 is downsampled by aggregating blocks of cells and replacing the blocks of cells by the aggregated value. The downsampled feature map is then input to the second convolutional neural network layer 512. In this way the convolutional filters of the second neural network layer 512 operate over a larger scale that those of the first neural network layer 506. Use of pooling is found to give improved accuracy of predictions.

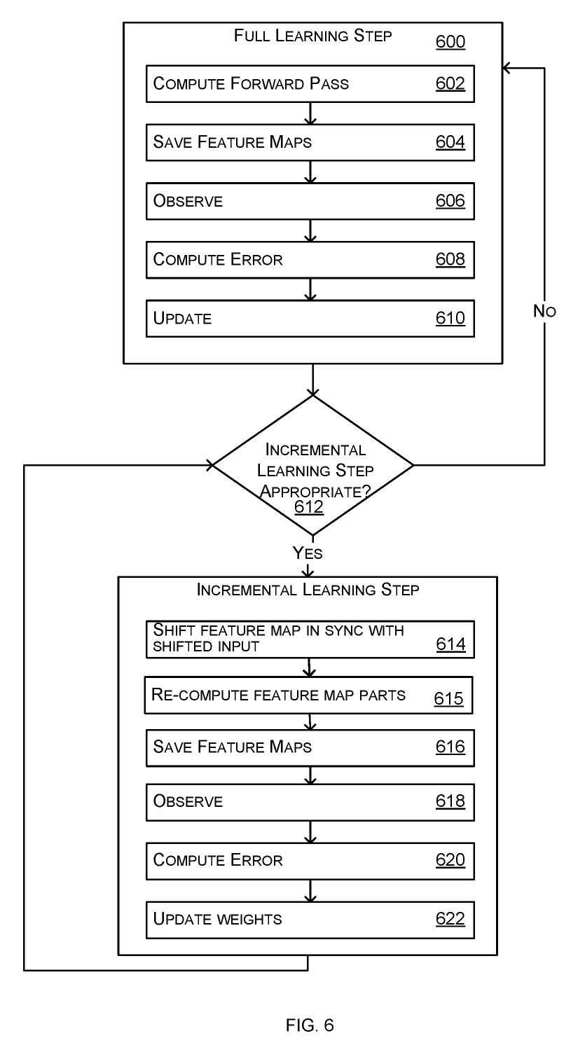

The process of computing the predicted output vector 520 is computationally expensive since the tensor is large and the number of parameters of the convolutional neural network layers is significant. In order to achieve substantial efficiencies the following insight is recognized herein. Since each row represents state at a time step, and when a new observation is made it is added to the right hand side of the input structure as a column (see column 524 in FIG. 5B), and the left most column 526 deleted, the data in all but the right most column of the input structure occurs in the current time step and also in the immediately previous time step. This means that parts of the feature map can be reused between time steps and significant amounts of the computation are avoided. The process for reusing parts of the computation during the computation of predictions is now explained in more detail with reference to FIG. 6.

Suppose the machine learning component at the digital twin is carrying out a full learning step 600 without any reuse of computation. A forward pass through the neural network is computed 602 and the intermediate prediction results (the feature maps) are saved 604. The empirical event data is observed 606 for the next time step and the error between the empirical event data and the prediction is computed 608. The weights of the neural network layers are then updated using backpropagation in a conventional manner.

A check is made at operation 612 as to whether or not to make an incremental learning step at the next training iteration. The check involves assessing one or more of the following factors: the size of the error at operation 608, the quality of the observed data at operation 606, the quality of the saved feature maps, the size of the time interval since the last learning step, the number of learning steps that have occurred since the last observation at operation 618, a user input event. Any one or more of the factors are hyperparameters used at operation 300 of FIG. 3.

If the incremental learning step is to proceed the machine learning component shifts the current feature map in synchrony with the shift made to the input tensor 614. The machine learning component then re-computes 615 the parts of the feature map which are affected by the shift in the input tensor. If a data value in the feature map results from a convolution using a convolutional filter that overlapped part of the input tensor which has changed, the data value is recomputed.

The feature maps computed in the forward pass are saved 616, the event data of the next time step is observed 618 and an error between the prediction and the observed event data is computed 620. The neural network weights are then updated 622 using backpropagation.

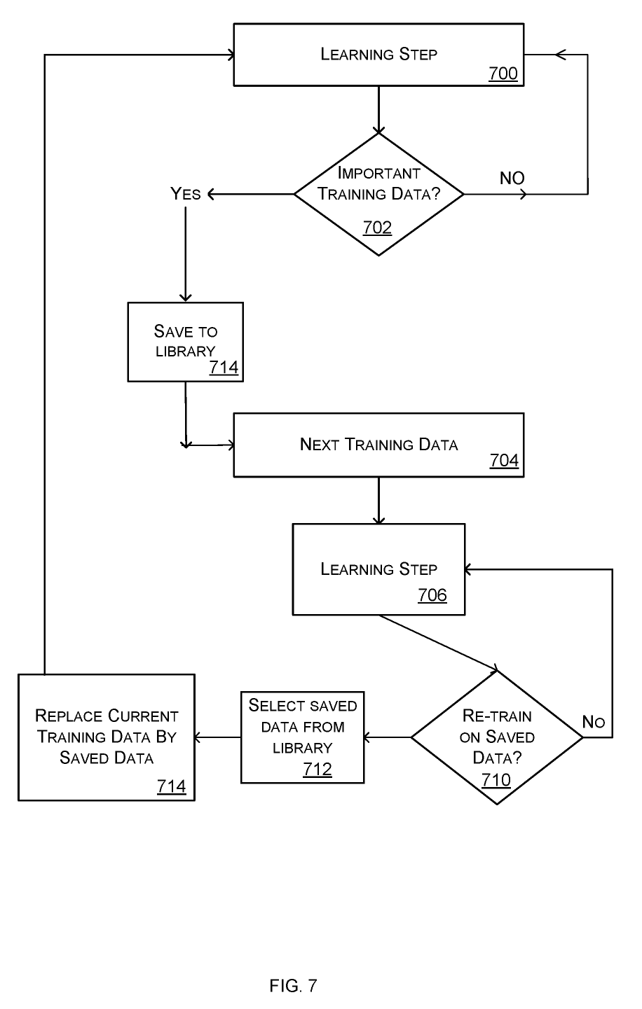

As mentioned above the machine learning component at a digital twin continues to learn using online learning as event data is observed. This means that significant events which are relatively rare become forgotten over time by the digital twin. In order to address this the machine learning component is configured to save event and/or state data observed during a significant event and to periodically retrain using the significant event data as explained with reference to FIG. 7.

Suppose the machine learning component has carried out a learning step 700 using the process of FIG. 3 at boxes 314 to 322. The machine learning component checks 702 whether the observed event data is important training data. The check is made by using data about the physical entities from another source. The other source comprises human input in some examples such as where a human rates the importance of the event. If the observed data is found to be important training data (where the human rating of importance is above a threshold) it is saved 714 to a library of training data about important events and the process moves to the next training data item 704 comprising a prediction from the neural network and a corresponding empirical observation. The data in the library comprises pairs of input matrices and associated predictions. Each input tensor is an input tensor put into the neural network for an important event. Each prediction is the prediction computed by the neural network at the time of the important event. A learning step 706 is carried out by computing the error between the prediction and the observation and using the error to update the weights of the neural network in a backpropagation process. The machine learning component then checks 710 whether to retrain using an item of the saved data from the library at operation 714. The check comprises checking 710 criteria such as one or more of: whether there is currently available compute resource at the digital twin, whether a specified time interval has elapsed, or whether a specified number of training iterations has elapsed.

If re-training is to be done, a training data item is selected 712 from the library of saved training data. The selection is made using a round robin selection process in some examples.

The current training data is replaced 712 by the selected item of saved data from the library of saved data. This is done by replacing the current input tensor of the neural network with the input tensor from the selected item of saved data. The selected item of saved data also has an associated stored prediction. A learning step is carried out (see operation 700) using the stored prediction as the observed data. The learning step 700 computes a prediction and an error is computed between the prediction and the stored prediction. The error is then used to update the weights of the neural network using backpropagation. The process of FIG. 7 then repeats.

FIG. 8 shows a parent digital twin 802 and a plurality of child digital twins 800. Each child digital twin 800 is the same as the digital twins of FIG. 1 and FIG. 2. A child digital twin receives event data 806 and computes output 804 comprising predictions and one or more feature maps which are the feature maps as illustrated in FIG. 5A and FIG. 5B. The predictions and feature maps deltas of the child digital twins are sent to the parent digital twin. (A feature map delta is the difference between a pair of feature maps where one feature map is at the time step immediately subsequent to the other feature map.) The parent digital twin has its own schema describing the incoming stream of predictions from the child digital twins and also describing event data 806 it receives directly. The parent digital twin knows the schemas of the child digital twins. The parent digital twin also has a prediction schema, which is a schema describing the incoming predictions from the child digital twins in a concise manner. The parent digital twin also has a copy of each of the feature maps of the digital twins. The parent digital twin updates its copies of the feature maps using the feature map deltas it receives from the child digital twins. The parent digital twin 802 computes its own predictions which are predictions of the behavior of the child digital twins and thus of the behavior of the physical entities corresponding to the child digital twins.

Using one or more parent digital twins is useful to make higher level predictions which take into account predictions of many child digital twins. It is also possible to have grandparent digital twins and so on to make higher level predictions about global behavior of a distributed system of physical entities. In this way very high quality control of physical entities is achieved by taking into account global behavior of the plurality of physical entities.

As mentioned above, in some examples the digital twins infer their own schemas automatically. More detail about how this is achieved is now given.

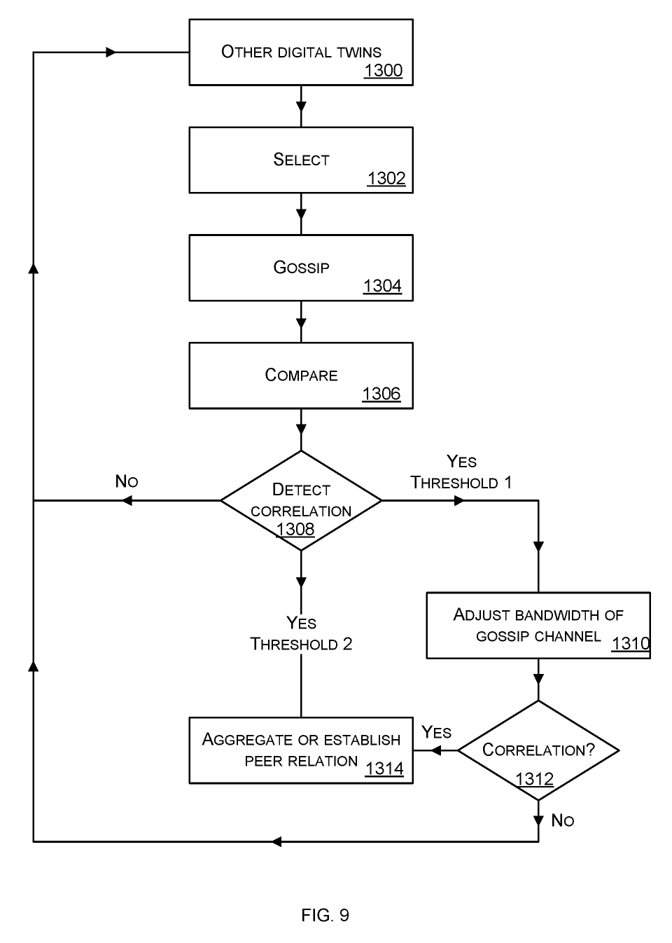

With reference to FIG. 9 each digital twin has a data ingestion component 906 which receives an event data stream 904 in real time, decodes data payloads of the event data stream, infers structural types present in the event data stream and carries out various other pre-processing tasks.

Each digital twin has a component for schema computation 908. This component takes output from the data ingestion component 906, where that output comprises structural types describing the event data streams, and computes a schema of the event data stream. The schema represents the observed data and is computed automatically from the observed data rather than being defined by a human operator. The schema is for interpreting the data in the event data stream and it comprises one or more fields, each field having a structural type and a range of possible values. A schema comprises structural types and metadata about the structural types. A non-exhaustive list of examples of metadata about structural types is: name of string, time range in which the schema was generated, information about how the schema has been used to compute a mapping, a user annotation.

The computing device 918 has a component for distributed inference 912. The distributed inference component 912 sends and receives data about the dynamic schemas and/or the event data, with other ones of the computing devices 918. The distributed inference component 912 makes comparisons and aggregates digital twins, or establishes peer relationships between digital twins, according to the comparison results. The data ingestion component 906, dynamic schema computation 908 and distributed inference 912 operate continually and at any point in time the current inferred digital twins 916 are available as output. Identification of any peers in the output digital twins is also output.

Alternatively, or in addition, the functionality of a digital twin described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

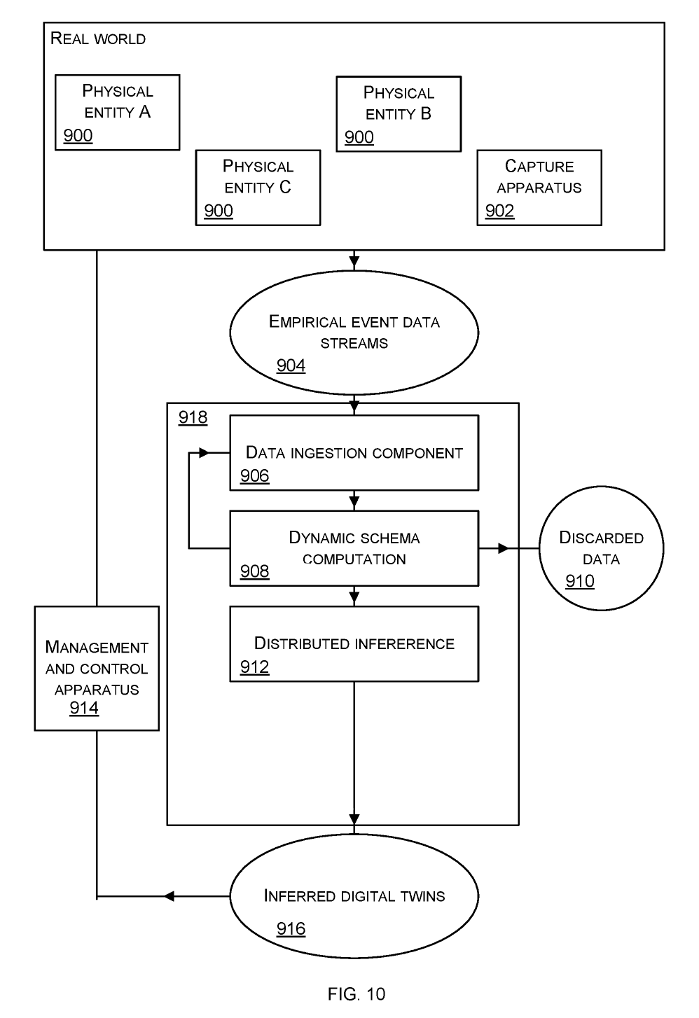

FIG. 10 shows a structural type system hierarchy which is an example of the library of structural types 1008 used by the data ingestion component. The structural type system hierarchy has a root type 1010 representing a set of structured values. The root type 1010 gives rise to a plurality of first level structural types which are: NoType 1012, LiteralType 1014, EnumType 1016, RangeType 1018, RecordType 1020, UnionType 1022 and AnyType 1024. The RecordType 1020 gives rise to a plurality of second level types which are ArrayType 1026, ObjectType 1028 and Member Type 1030. In FIG. 10 the types within the hierarchy are ordered by level of generality of the types with the most precise types on the left hand side and the most general types on the right hand side. NoType 1012 is the type of the empty set of values. LiteralType 1014 is the type of a set with exactly one value. EnumType 1016 is a precise type of a set with more than one value. RangeType 1018 represents a bounded range of ordered values. RecordType 1020 represents a set of aggregate values. Within RecordType 1020, the ArrayType 1026 represents a set of arrays with elements of a given type, the ObjectType 1028 represents the set of associated arrays with fields of a given type, and MemberType 1030 represents a set of aggregate types that contain an element of a given type. UnionType 1022 represents the union of multiple types. AnyType 1024 is the set of all values.

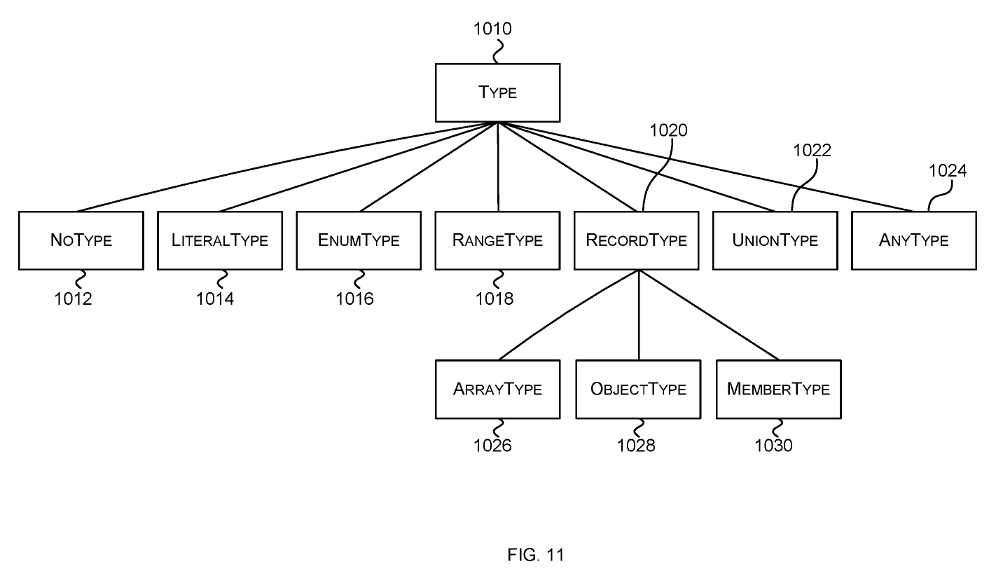

FIG. 11 is a flow diagram of a method of structural type inference suitable for use by the data ingestion component. The process of FIG. 11 is a repeating process carried out by a primitive digital twin; it repeats as new values from the event data stream are observed. The process takes values from the decoded event stream and computes one or more structural types which represent the decoded event stream data which has been observed recently in an extremely concise form. The structural types inferred change over time, such as where the primitive digital twin begins operation and has little knowledge of the event data stream and learns the structural types over time as more data from the event data stream is observed.

The process of FIG. 11 is thus a data compression process although it is not reversible; that is a structural type inferred using the process of FIG. 11 cannot be used to regenerate the exact same event data which led to generation of the structural type.

The process of FIG. 11 is specially designed to work with structured values in the decoded event stream (such as arrays and other data structures). It is complex to deal with structured values (as opposed to unstructured values) because the structure of the structured values is not known by the primitive digital twin and it needs to be discovered and persisted. The information about the structure of the values in the event data stream is very important for predicting the behavior of the physical object or process that the digital twin represents. However, it is not straightforward to find this structure since there is no knowledge about the structure available to the primitive digital twin from sources other than the event stream itself.

The primitive digital twin tries to find a way to compress the event data stream because it is not practical to retain all the data in the event data stream. However, if conventional data compression methods are used the structure in the event data stream is lost or corrupted.

The method of FIG. 11 provides a way to infer structural types (from the hierarchy of FIG. 10) which are present in the event data stream and as part of this inference process the event data stream is compressed into the inferred structural types. For example, a stream of event data from a traffic light in the real world is compressed using the method of FIG. 11 into three structural types: a literal type representing an identifier of the traffic light, an Enumtype comprising four specific values of a temperature sensor at the traffic light, and a range type representing a range of values from a humidity sensor at the traffic light.

The process of FIG. 11 describes the case of inferring one structural type. In practice there are typically a plurality of different structural types in the event data stream and so the process of FIG. 11 happens in parallel for each of the structural types.

The process of FIG. 11 begins with the primitive digital twin initializing 1120 an inferred type by setting the inferred type to an initial default structural type, such as the root structural type from the structural type hierarchy of FIG. 10. The primitive digital twin takes 1122 a value from the decoded event stream such as by taking the next value from that stream. The primitive digital twin sets 1124 the structural type of the value to its literal type. The literal type of the value taken from the event stream is found by inspecting the value and comparing it with a plurality of possible literal types.

The primitive digital twin computes 1126 a least upper bound between the inferred type and the literal type. The least upper bound of a structural type A, and a structural type B, is the minimal structural type that includes all values of structural type A, and all values of structural type B (where the minimal type is the smaller type in terms of memory size needed to store the type in a memory). An approximation to the least upper bound of structural type A and structural type B is computed in an efficient manner by computing a union of structural type A and structural type B. A least upper bound is less precise than a union, however despite that difference, the process of FIG. 11 is found to give good results in practice and by using the more efficient union computation significant efficiencies are gained which make it possible to scale up the process of FIG. 11 for high data rates on the incoming event stream.) The least upper bound is computed by taking a union between the inferred type and the literal type.

The primitive digital twin checks 1128 whether the least upper bound result is different from the inferred type. If so, the inferred type is set 1130 to be the least upper bound result and the process continues at operation 1132 by checking the size of the inferred type. If the check at operation 1128 shows that the least upper bound result is the same as the current inferred type then the process moves directly to operation 1132.

At operation 1132, if the inferred type is larger than a threshold the inferred type is simplified 1134 in order to reduce its size. In an example, to simplify an EnumType comprising a list of values a range type is computed which expresses the range of values in the EnumType rather than listing each of the values in the EnumType. More generally, an inferred type is simplified by using the structural type hierarchy of FIG. 10 to compute a type which is more general than the inferred type and so which is further to the right hand side in the hierarchy of FIG. 10 than the inferred type itself. Since the simplified type is more general than the inferred type the simplified type has less information than the inferred type and so is smaller. Use of the structural type hierarchy to simplify the inferred type gives a principled and effective way of compressing the data from the event stream which is found to work extremely well in practice.

After the inferred type has been simplified at operation 1134, or has been found to be smaller than the threshold at operation 1132, the process returns to operation 1122 at which the next value from the decoded event stream is taken to be processed using the method of FIG. 11. Thus the process of FIG. 11 runs repeatedly such as at regular or irregular time intervals. At any point in time the current inferred type is read out from the process of FIG. 11 for use by the primitive digital twin in schema inference as described below.

The process of FIG. 11 is nested in some cases. That is, where the structural type inferred in FIG. 11 itself comprises one or more other structural types, the process of FIG. 11 is used recursively. Thus in the case of structural types such as arrays the process of FIG. 11 is used many times, once for each field of the array.

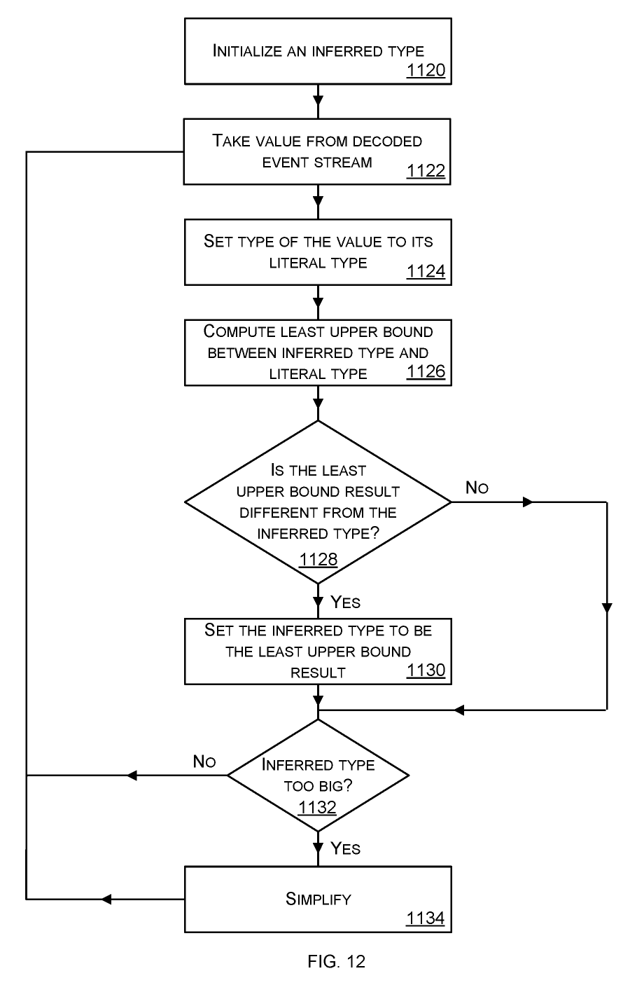

FIG. 12 is a schematic diagram of an example of dynamic schema computation. Dynamic schema computation takes inferred structural types computed by the data ingestion component and computes schemas from these. Recall that a schema is one or more structural types with metadata. The process of FIG. 12 has access to inferred structural types from the process of FIG. 11 which is done by the data ingestion component. The process of FIG. 12 is performed by a primitive digital twin.

A data source 1206 of captured event data is fed to a computing device 1202 executing the primitive digital twin, such as an edge device or other computing device. The primitive digital twin buffers event data items, of the same structural type, for K events from the event data stream in buffer 1200. It computes the union between pairs of event data items in the buffer to produce a field of a schema 1204. The buffer is then emptied. This process repeats for other structural types, one for each field of the schema. Note that the primitive digital twin has the structural type information since this has been computed using the process of FIG. 3C. In practice the processes of FIG. 11 and FIG. 12 execute in parallel. By executing in parallel, the most up to date inferred structural types are available to the process of FIG. 12 which improves accuracy. The process of FIG. 12 repeats over time so that the schema 1204 is dynamic since it is continually updated.

Computing the union is a fast, efficient and effective way of enabling the computing device to retain useful parts of the event data in the schema and discard the majority of the event data. Thus the computing device is able to operate for huge amounts of event data without breaking down or introducing errors.

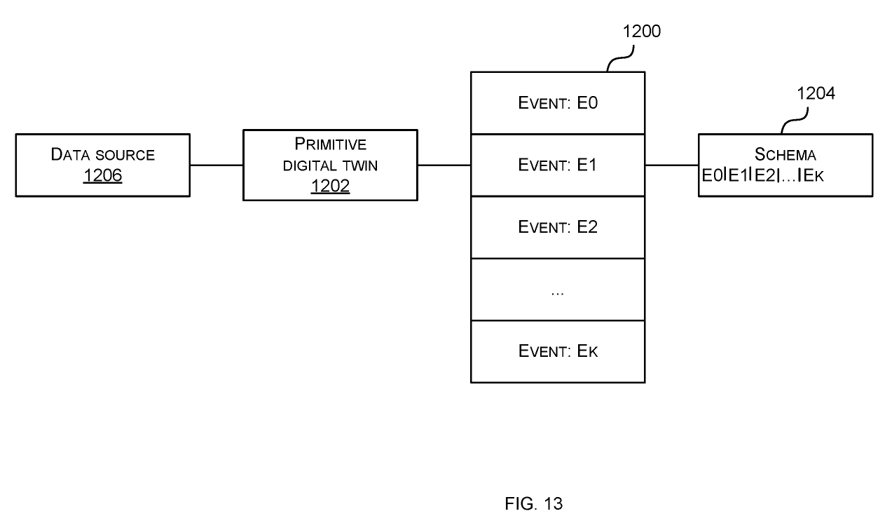

As mentioned above a process of distributed inference between two or more primitive digital twins takes place in order to infer digital twins and infer relationships between the digital twins as now described with reference to FIG. 13.

FIG. 13 is a flow diagram of an example of a method of distributed inference. The method of FIG. 13 is performed by a digital twin at a computing device such as an edge computing device or other computing device. The computing device comprises a digital twin which in some examples is a primitive digital twin. The digital twin at the computing device has knowledge about one or more other primitive digital twins 1300 in communication with it via a communications network of any type. The knowledge is preconfigured or is obtained from another computing system. At this point the digital twin at the computing device does not know how many physical objects there are and what the relationship is between the physical objects and the potential digital twins. Peer relationships between digital twins are unknown at this point.

The digital twin at the computing device selects 1302 one of the other primitive digital twins. The selection is random or according to one or more heuristics. An example of a heuristic is to select a digital twin with the closest physical proximity.

The digital twin at the computing device gossips 1304 with the selected primitive digital twin using a communications channel between the computing device and the selected primitive digital twin, referred to as a gossip channel. Gossiping means sending and receiving data about dynamic schemas or event data. The computing device compares 1306 the sent and received data. If a potential correlation is detected 1308 between the sent and received data then a bandwidth of the gossip channel is increased. If a potential correlation is not detected then the process returns to operation 1300 and another one of the other primitive digital twins is selected at operation 1302. Any well know statistical process is used to compute the correlation.

If a potential correlation is found at check 1308 and the correlation is above a first threshold amount but below a second threshold amount, the process proceeds to operation 1310. At operation 1310 the bandwidth of the gossip channel between the present digital twin and the other primitive digital twin which was selected at operation 1302 is increased. The increased bandwidth is used to gossip larger amounts of data so that finer grained data is communicated between the gossip partners of the gossip channel. Once the larger amounts of data are gossiped an assessment of correlation between the data sent and received over the gossip channel is made. The assessment is indicated at check point 1312 of FIG. 13. If the assessment finds insufficient evidence for correlation the process returns to operation 1300 and repeats. If the assessment finds sufficient evidence for correlation the process either aggregates 1314 the present digital twin and the primitive digital twin selected in operation 1302 (that is, the digital twins of the gossip channel), or the process establishes a peer relation. Aggregation is done when, for practical purposes, there is insignificant difference between the sent and received data on the gossip channel so that both the digital twins on the gossip channel effectively have the same schema. A peer relation is established when the data sent on the gossip channel is essentially the same as the data received on the gossip channel, except for at least one field of the schema which is consistently the same in the sent data, and at least one field of the schema which is consistently the same in the received data but different from the field which is consistently the same in the sent data. An inference is made that the schema which is consistently the same in the sent data represents an identifier and the same is done for the received data. In this way an inference is made that there are two separate digital twins and these separate digital twins have the same behavior. In reality the two separate digital twins may be two street lights of the same type but in different locations (for example) where the street lights operate in the same manner.

When two primitive digital twins are aggregated this is done by deleting one of the two primitive digital twins after having redirected the event stream of the deleted primitive digital twin to the remaining primitive digital twin of the two. When two primitive digital twins are found to have a peer relation there is no change to the digital twins themselves, although these two digital twins now have stored information indicating the identity of a peer.

Operation 1314 is also reached directly from operation 1308 in cases where the correlation at operation 1314 is above a second threshold which is higher than the first threshold.

In this way the method of FIG. 13 enables aggregation or peer relations to be established in an efficient manner. This is because, if the correlation is found to be strong at check 1308 there is no need to adjust the bandwidth of the gossip channel at operation 1310 which is resource intensive and time consuming.

The method of FIG. 13 is very effective since if a potential correlation is detected at operation 1308, at a point when the gossiped information is extremely concise, the process of 1310 is used to check whether there is in fact a correlation. This greatly improves accuracy since errors where noise in the gossiped data is mistakenly detected as indicating a need for aggregation or a peer relation, are significantly reduced.

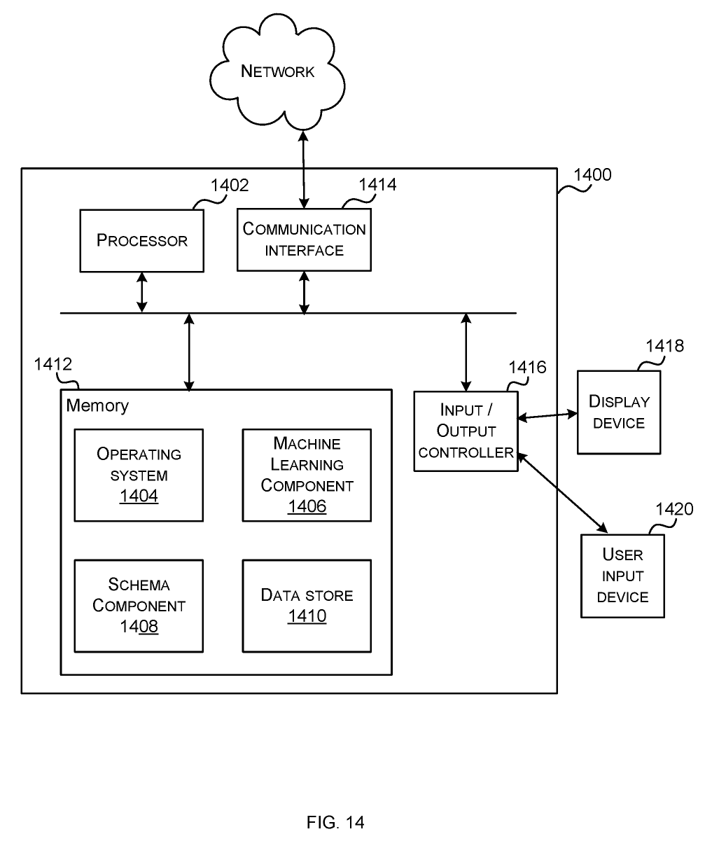

FIG. 14 illustrates various components of an exemplary computing-based device 1400 which are implemented as any form of a computing and/or electronic device, and in which embodiments of a digital twin are implemented in some examples.

Computing-based device 1400 comprises one or more processors 1402 which are microprocessors, controllers or any other suitable type of processors for processing computer executable instructions to control the operation of the device in order to compute predictions, execute online training, periodically retrain using significant training data and compute predictions for hypothetical scenarios. In some examples, for example where a system on a chip architecture is used, the processors 1402 include one or more fixed function blocks (also referred to as accelerators) which implement a part of the method of any of FIGS. 2 to 7, 9 and 11 to 13 in hardware (rather than software or firmware). Platform software comprising an operating system 1404 or any other suitable platform software is provided at the computing-based device to enable application software to be executed on the device including a data ingestion component 1406 and a schema inference component 1408. Data store 1410 holds parameter values, event data, inferred structural types, a structural type hierarchy, schemas, inferred key relations, peer relationships and other data.

The computer executable instructions are provided using any computer-readable media that is accessible by computing based device 1400. Computer-readable media includes, for example, computer storage media such as memory 1412 and communications media. Computer storage media, such as memory 1412, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 1412) is shown within the computing-based device 1400 it will be appreciated that the storage is, in some examples, distributed or located remotely and accessed via a network or other communication link (e.g. using communication interface 1414).

The computing-based device 1400 optionally comprises an input/output controller 1416 arranged to output display information to an optional display device 1418 which may be separate from or integral to the computing-based device 1400. The display information may provide a graphical user interface such as for displaying inferred types, schemas, inferred key relations, inferred digital twins and other data. The input/output controller 1416 is also arranged to receive and process input from one or more devices, such as a user input device 1420 (e.g. a mouse, keyboard, camera, microphone or other sensor). In some examples the user input device 1420 detects voice input, user gestures or other user actions and provides a natural user interface (NUI). This user input may be used to set parameter values, view results and for other purposes. In an embodiment the display device 1418 also acts as the user input device 1420 if it is a touch sensitive display device.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A computer-implemented method performed by a digital twin at a computing device in a communications network, the method comprising:
receiving a plurality of streams of event data observed from the environment, at least one of the streams of event data being from another digital twin in the communications network;
accessing, for each received stream of event data, a schema, the schema being a concise representation of the stream of event data;
mapping the event data from the plurality of streams into an input structure, on the basis of the schemas;
computing a prediction of event data of the stream of event data received directly at the digital twin by inputting the input structure to a machine learning component;
such that the prediction may be used to facilitate one or more of configuration, management, control, maintenance, of a physical entity represented by the digital twin.

2. The method of claim 1 wherein each digital twin models a physical entity in the real world, where the physical entity is an apparatus or a process, and wherein the method comprises any one or more of: configuring, managing, controlling, maintaining the physical entities using the prediction.

3. The method of claim 1 wherein receiving the streams of event data comprises receiving the event data in a de-duplicated form by receiving, for individual ones of the streams, deltas which are differences between already received event data of the stream and more recent event data of the stream.

4. The method of claim 1 where the machine learning component input structure is a tensor comprising a plurality of columns, each column storing event data from a same time step, and where the columns are ordered chronologically by time step.

5. The method of claim 4 where each column stores event data from each event stream relating to the same time step.

6. The method of claim 4 wherein each row of the tensor stores event data in a concise form specified by the schemas.

7. The method of claim 4 wherein the values in the tensor are normalized according to ranges of range structural types of the schemas.

8. The method of claim 1 wherein the mapping comprises a reduction function which aggregates event data within a time step.

9. The method of claim 1 comprising any one or more of: adding to, editing, deleting from, the input structure prior to computing the prediction.

10. The method of claim 1 comprising observing event data of the streams of event data with at a time step corresponding to a time step of the prediction, computing an error between the observed event data and the prediction and updating the machine learning component according to the error.

11. The method of claim 1 wherein the machine learning component comprises a plurality of convolutional neural network layers and at least one fully connected layer.

12. The method of claim 10 wherein updating the machine learning component according to the error comprises using either a full learning step or an incremental learning step according to criteria, and wherein the incremental learning step comprises reusing saved intermediate prediction results for time steps of the input structure except the most recent time step.

13. The method of claim 12 wherein the saved intermediate prediction results comprise feature maps output from hidden layers of a neural network in the machine learning component.

14. The method of claim 10 comprising, if the observed event data meets criteria, saving the observed event data as historic event data, and at a later time, replacing the current observed event data by the historic observed event data prior to computing the prediction.

15. The method of claim 14 wherein the criteria comprise conditions about data received from a signal comprising one or more of: user input, a digital twin output, a sensor signal, a signal from another computing system.

16. The method of claim 1 wherein the digital twin is a parent digital twin and at least one of the other digital twins is a child digital twin.

17. The method of claim 16 comprising receiving, at the parent digital twin, predictions and deltas of feature maps from the child digital twin, wherein the parent digital twin stores a prediction schema, which is a concise representation of the predictions received from the child digital twins.

18. The method of claim 17 comprising updating a copy of the feature maps stored at the parent digital twin, using the received deltas of feature maps.

19. A computing device in a communications network, the computing device comprising a digital twin configured to:
receive at least one stream of event data observed from the environment;
compute at least one schema from the stream of event data, the schema being a concise representation of the stream of event data;
participate in a distributed inference process by sending information about the schema or the received event stream to at least one other digital twin in the communications network and receiving information about schemas or received event streams from the other digital twin;
compute comparisons of the sent and received information;
aggregate the digital twin and the other digital twin, or establish a relationship between the digital twin and the other digital twin on the basis of the comparison.

20. A communications network comprising a plurality of digital twins each digital twin comprising:
processor configured to receive at least one stream of structured event data observed from the environment;
compute at least one schema from the stream of event data, the schema being a concise representation of the stream of event data;
participate in a distributed inference process by sending information about the schema or the received event stream to at least one other digital twin in the communications network and receiving information about schemas or received event streams from the other digital twin;
compute comparisons of the sent and received information;
aggregate the digital twin and the other digital twin, or establish a relationship between the digital twin and the other digital twin on the basis of the comparison.
